(19) United States
(12) Patent Application Publication
(10) Pub. No.: US 2026/0350636 A1
(43) Pub. Date: Nov. 5, 2026

(54) METHOD FOR GENERATING AND MANAGING, BY MEANS OF ELECTRONIC COMPUTATION, A DIGITAL EQUIVALENT OF A PHYSICAL PIECE OF ARTISTIC AND/OR HISTORICAL AND/OR CULTURAL VALUE

(71) Applicants: Francesco FLAMINI, BOLOGNA (IT); Valerio GALLI, BOLOGNA (IT)

(72) Inventors: Francesco FLAMINI, BOLOGNA (IT); Valerio GALLI, BOLOGNA (IT)

(21) Appl. No.: 19/102,870

(22) PCT Filed: Aug. 9, 2023
(86) PCT No.: PCT/IB2023/058042

§ 371 Date: Feb. 11, 2025

(30) Foreign Application Priority Data
Aug. 11, 2022 (IT) 102022000017184

(51) Int. Cl. G06Q 30/018

(52) U.S. Cl. CPC G06Q 30/0185

(57) ABSTRACT

Disclosed are system and method for generating and managing a digital equivalent of a physical piece or artefact and/or historical and/or cultural value. The method first comprises a step of dynamically generating and certifying visual contents, based on digital images and/or other digital information of the physical piece acquired or received dynamically, to generate certified visual contents, which are accessible by means of electronic processing means, so as to allow a two-dimensional and/or three-dimensional display of the physical piece. The method further provides dynamically recording and certifying operations performed on the physical piece and/or events related to the physical piece and/or documentation or reporting concerning the physical piece, to generate a set of certified dynamic digital data representative of the history of the physical piece. The aforesaid actions aimed at the certification can be carried out by means of a distributed electronic certification system interoperating with the electronic processing means.

### TECHNOLOGICAL BACKGROUND OF THE INVENTION

### Field of Application

The present invention relates to a method for generating and managing, by means of electronic computation, a digital equivalent of a physical piece or artefact, in particular of a physical piece or artefact of artistic and/or historical and/or cultural value.

### Description of the Prior Art

In the field of digitizable intellectual property (for example, images, books, audio stories, etc.), Non-Fungible Token technologies (NFT) have recently emerged and are developing rapidly.

As it is well known, an NFT is a special type of token which represents the title deed and the certificate of authenticity written on a blockchain of a unique digital asset.

NFTs are used in several specific applications which require unique digital items.

Regarding this, it would be desirable to apply technologies of the NFT type also to digital assets which are a piece of art and/or a physical piece or artefact, and, more specifically, which are uniquely associated with the piece of art and/or physical piece or artifact.

Such a need is expressed both by museums or public or private institutions or organizations of artistic and/or historical and/or cultural nature (which are, for example, owners of the original physical piece, and can be owners or concessionaires or guarantors of the equivalent digital piece, which they can desire to sell in whole or in part) as well as by collectors or potential buyers of the digital piece.

There are no known direct applications of NFTs in this field.

From a technical point of view, this is related to the fact that NFTs are not adapted to this type of use, since they are by nature immutable and non-dynamic, while the digital pieces representing pieces of art (and many potential information associated therewith) need to be dynamic.

Furthermore, as it is known, known “smart contracts”, for example those based on blockchains, once closed are unmodifiable, and therefore do not meet to the above requirement.

Therefore, the need remains unsatisfied for methods for generating and managing, by means of electronic computation, a digital equivalent of a physical piece or artefact which overcome the aforesaid drawbacks and are capable of certifying, authenticating and possibly exchanging and/or trading, in an updatable, dynamic and secure manner, digital pieces associated with physical pieces or artifacts.

### SUMMARY OF THE INVENTION

It is the object of the present invention to provide a method for generating and managing, by means of electronic computation, a digital equivalent of a physical piece or artefact, which allows solving, at least partially, the drawbacks claimed above with reference to the prior art, and responding to the aforementioned needs particularly felt in the technical field considered. Such an object is achieved by a method according to claim 1.

Further embodiments of such a method are defined by claims 2-13.

It is a further object of the present invention to provide a system which is capable of performing the aforesaid method. Such an object is achieved by a system according to claim 14.

Further embodiments of such a system are defined by claims 15-16.

### BRIEF DESCRIPTION OF THE DRAWINGS

Further features and advantages of the method according to the invention will become apparent from the following description of preferred embodiments, given by way of non-limiting indication, with reference to the accompanying drawings, in which:

FIG. 1 shows, by means of a simplified and exemplary block diagram, an embodiment of the system and method according to the invention.

### DETAILED DESCRIPTION

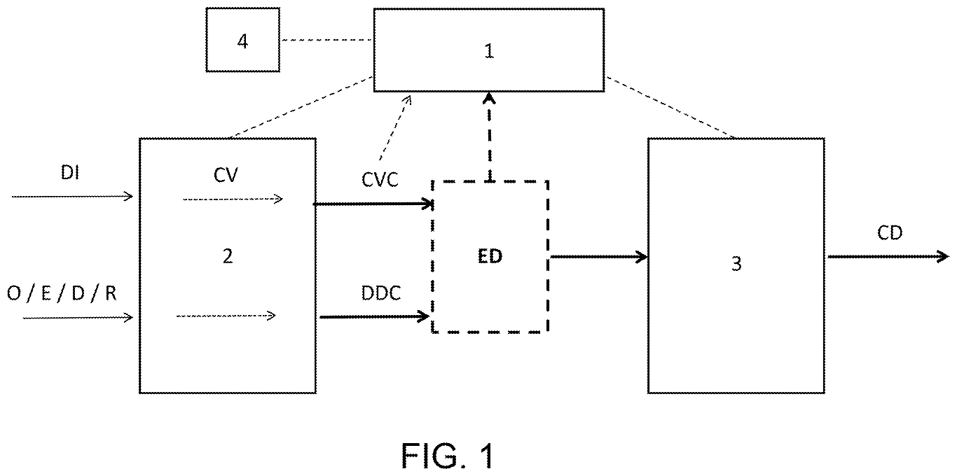

With reference to FIG. 1, there is described a method for generating and managing, by means of electronic computation, a digital equivalent ED of a physical piece or artefact, in particular a physical piece or artefact of artistic and/or historical and/or cultural value.

The method first comprises a step of dynamically generating and certifying visual contents CV, based on digital images DI and/or other digital information of the physical piece or artefact acquired or received dynamically, to generate certified visual contents CVC, which are accessible by means of electronic processing means 1, so as to allow a two-dimensional and/or three-dimensional display of the physical piece or artefact.

The aforesaid certification step is carried out by means of a distributed electronic certification system 2 interoperating with said electronic processing means 1.

The method further provides dynamically recording and certifying operations O performed on the physical piece or artefact and/or events E related to the physical piece or artefact and/or documentation D or reporting R concerning the physical piece or artefact, to generate a set of certified dynamic digital data DDC representative of the history of the physical piece or artefact. The aforesaid certification can be carried out by means of the aforesaid distributed electronic certification system 2 interoperating with the electronic processing means 1.

The method further comprises the step of generating a digital database representing the digital equivalent ED of the physical piece and/or artefact, based on both the aforesaid certified visual contents CVC and the aforesaid set of certified dynamic digital data DDC representative of the history of the physical piece or artefact.

The aforesaid step of generating a digital database representing the digital equivalent ED of the physical piece and/or artefact comprises generating a database constantly updated with visual contents and events relating to the physical piece, creating a unique and dynamically updated link between the physical piece and the equivalent digital piece ED.

Finally, the method includes generating and certifying a digital contract of ownership or use CD of the aforesaid equivalent digital piece ED, by means of a system 3 for generating and certifying digital contracts, interoperating with the aforesaid electronic processing means 1.

According to an embodiment of the method, the aforesaid digital contract of ownership or use CD of the equivalent digital piece ED is a dynamically variable digital contract, in which the certified data which make up the database included in the equivalent digital piece ED are dynamically updatable, and represent a dynamic digital equivalent of the piece of art.

According to an embodiment of the method, the aforesaid visual contents CV comprise visual contents with augmented reality.

According to an implementation option, for example one with augmented reality technology, the mechanism is used of overlaying digital content on the real environment by means of the use of hardware devices provided with cameras.

For example, an edge-based tracking algorithm is used so as to have digital content overlay. The digital content is represented, for example, by textual information or free images, and/or textual information and/or images linked to a point of the physical piece, and/or hyperlinks, and/or documents, and/or links to other digital contents.

According to an embodiment of the method, the aforesaid visual contents CV comprise visual contents with virtual reality.

According to an implementation option, virtual reality technologies are used based on the use of suitable hardware tools, for example 3D viewers, which, by means of a reconstruction of the position in the real space of the observation point, allow to be immersed in a totally virtual environment.

The data present in the virtual environment are, for example, a 3D reconstruction of the real piece or artifact, with additional information such as those reported for the augmented reality example. The user has the possibility to interact with the information to use it as well as to add complementary information or share further details with other users.

In accordance with an embodiment of the method, the digital equivalent ED of the physical piece and/or artefact comprises both the aforesaid certified visual contents CD and the aforesaid set of certified dynamic digital data DDC representative of the history of the physical piece or artefact.

According to various possible implementation options, the physical piece or artefact of artistic and/or historical and/or cultural value, to which the method disclosed herein can be applied, is a piece of art owned by a museum or by a public or private institution or organization of artistic and/or historical and/or cultural nature.

According to an embodiment of the method, the aforesaid visual contents CV (also in the implementation option which involves augmented and/or virtual reality) are usable by means of user devices 4, such as a computer or a mobile device or a smartphone, adapted to digitally communicate and interoperate (in a manner known per se) with electronic processing means 1.

According to an embodiment, the aforesaid electronic processing means 1 comprise a computerized platform comprising one or more electronic processors capable of carrying out operations based on one or more software programs stored therein and executable thereby.

According to various possible implementation options, the software programs are distributed on the electronic processing means 1 by an access to a distribution platform, by means of which possible updates are released and connections are created for a distributed validation of updated contents and access rights.

To do this, it is sufficient for the user to have a client (i.e., a “client program”) of the platform itself installed on his/her computer and to have an internet connection to connect to the platform.

According to an implementation option, access is obtained by means of a unique authentication.

In accordance with an embodiment, the aforesaid distributed electronic certification system 2 comprises an electronic certification system based on Blockchain technology.

Certification via blockchain, known per se, has the purpose of certifying the information present in the digital content and the access thereto with a distributed system. In fact, the platform made available by the present invention allows the exchange and sale of the right to access the digital content and such transactions are validated, for example, by means of distributed consent.

According to some possible implementation options, some steps of the method can be implemented by means of techniques used in the Non-Fungible Token field (NFT).

However, it should be noted that the method disclosed above, as a whole, allows obtaining a result which is very different from an NFT, and more advanced in terms of modifiability and dynamism.

In fact, as disclosed above, the certified data which make up the database included in the digital equivalent of the piece can be dynamically updated with this method, thus obtaining a dynamic digital equivalent of the piece of art (and not a mere static NFT, or a smart contract, which, once closed, cannot be modified).

According to an implementation option, this function is achieved by means of the development of a proprietary method for accessing digital data, described herein. While the digital content is owned by the owner of the physical piece (for example a Museum), the use thereof is granted to those who purchase it by accepting the conditions of use.

In this particular implementation option, the user can access encrypted data and use it by installing proprietary software on the device and accepting that this can constantly exchange data with the platform. The data is analyzed to ensure compliance with the contract itself and the digital content is periodically updated and released as a new version.

According to an embodiment, the aforesaid step of generating visual contents CV is carried out by means of augmented reality techniques based on tags, adapted to dynamically manage data and information relating to the physical piece or artefact.

According to an implementation option, digital content can be created using an augmented reality software, known per se. This exemplary scenario involves, for example, a researcher who, during analyses, using a hardware device, views the digital content added to the piece and contributes thereto by uploading further content as a result of the analyses. All contents can be subject to an approval process.

In accordance with an implementation option of the method, the aforesaid step of generating visual contents with augmented reality is carried out based on data obtained within the context of operations for digitizing artistic/cultural heritage.

According to an implementation option, the augmented reality software can host, in the database thereof, 3D scans already made in the past by the owners of the piece, as well as, advantageously, migrate within the platform the data present in the management systems currently used by museums, so as to benefit from the amount of data already circulating.

According to various possible implementation options of the method, the aforesaid recording and certifying step comprises dynamically recording and certifying one or more of the following information:
documents and/or images and/or other information relating to the physical piece or artefact;
historical and/or diagnostic and/or scientific reports relating to the physical piece or artefact;
operations relating to the history of the physical piece or artefact, such as loans, logistical arrangement, cataloging, archiving.

According to particular implementation options of the method, the conventional data which contribute to the digital content, in addition to the 2D or 3D scan of the piece, consist of the digitization of the ministerial files of the piece, and/or results of physical/chemical analyzes on parts of the piece in the form of images or pdf reports, and/or historical and attribution reports of the piece, and/or bibliographic references, and/or exhibition history. For example, this data is entered by the team of experts who operate at the entity which owns the physical piece and have the skills to create this data and the authority to approve it.

According to an embodiment of the method, the access and/or use and/or exchange of data relating to said equivalent digital piece ED occurs based on authentication procedures, based on encryption techniques. Such authentication procedures are adapted to provide regulated access, according to a predefined hierarchy of levels, to personnel including the owner of the digital piece, the organization owning the physical piece, personnel of the organization owning the physical piece, personnel involved in the management or use of the physical piece, such as restorers or researchers.

According to an implementation option, the certification occurs, for example, by means of a double key and/or, for those who must approve the content, by executing a transaction on the blockchain with distributed verification of the validity of the operation.

In accordance with an application example, the method comprises the further step of allowing exchanges, loans, purchases or sales of the equivalent digital piece ED by means of a platform for managing the market of equivalent digital pieces, interoperating with the aforesaid electronic processing means 1, or included therein.

Again with reference to FIG. 1, hereinbelow there is described a system for generating and managing, by means of electronic computation, a digital equivalent ED of a physical piece or artefact, in particular a physical piece or artefact of artistic and/or historical and/or cultural value.

The system comprises electronic processing means 1 and further comprises a distributed electronic certification system 2 and a system 3 for generating and certifying digital contracts, interoperating with the electronic processing means 1.

The aforesaid electronic processing means 1 are configured to:
dynamically generate, based on digital images DI and/or other digital information of the physical piece or artefact, certified visual contents CVC;
allow access to the visual contents CVC generated, so as to allow a two-dimensional and/or three-dimensional display of the physical piece or artefact;
generate a digital database representing the equivalent digital piece ED of the physical piece and/or artefact, based on the aforesaid certified visual contents CVC and said set of certified dynamic digital data DDC representative of the history of the physical piece or artefact.

The aforesaid digital database is constantly updated with visual contents and events relating to the physical piece, creating a unique and dynamically updated link between the physical piece and the equivalent digital piece.

The aforesaid distributed electronic certification system 2 is configured to:
dynamically record and certify operations O carried out on the physical piece or artifact and/or events E relating to the physical piece or artifact and/or documentation D or reporting R relating to the physical piece or artifact;
generate the aforesaid set of certified dynamic digital data DDC representative of the history of the physical piece or artefact, based on digital data produced by the aforesaid recording and certifying step.

The aforesaid system 3 for generating and certifying digital contracts is configured to generate and certify a digital contract of ownership or use CD of the aforesaid equivalent digital piece ED.

According to an implementation option, such a digital contract of ownership, written for example in one of the languages available in the blockchain environment, protects the use and exchange of digital content by means of a distributed ledger.

Access to the actual digital content, and therefore the use thereof, is also ensured by means of a software (for example, a proprietary software) to be installed on the user device, constantly updated with the data entered by the museum.

According to several possible embodiments, the system is configured to perform a method for generating and managing a digital equivalent of a physical piece or artifact according to any of the embodiments of the method previously described.

It is worth noting that the object of the present invention is fully achieved by the method and system disclosed above by virtue of the respective functional and structural features.

In fact, the solutions described above allow generating and managing, by means of electronic computation, a digital equivalent of a physical piece or artefact which is capable of certifying, authenticating and possibly exchanging and/or trading, in an updatable, dynamic and secure manner, digital pieces associated with physical pieces or artifacts.

This offers clear benefits both to museums or public or private institutions or organizations of artistic and/or historical and/or cultural nature (which are, for example, owners of the original physical piece, and can be owners or concessionaires or guarantors of the equivalent digital piece, which they can desire to sell in whole or in part) as well as to collectors or potential buyers of the digital piece.

The aforesaid technical advantages provided by the invention therefore enable further “commercial” and usage advantages, mainly linked to the creation of a new value chain which uses the digital medium to create a new fundraising system for public and private organizations which hold artistic heritage.

In this sense, such organizations can benefit from a system promoting the assets thereof through the sale and purchase of the digital twin of a physical piece by means of the platform and from subsequent amounts obtained by the resale of such a digital twin.

In addition to what has been stated, such a mechanism allows developing new marketing levers to raise awareness of artistic heritage which otherwise would not be visible and exploitable, such as, for example, those pieces kept in warehouses or pieces which, despite having a great value, can be defined as minor. A further advantage of the system is that related to particular or ancillary rights linked to the purchase of the digital piece.

Those skilled in the art may make changes and adaptations to the embodiments of the method and system described above or can replace elements with others which are functionally equivalent in order to meet contingent needs without departing from the scope of the following claims. All the features described above as belonging to one possible embodiment can be implemented irrespective of the other embodiments described.

What is claimed:

1. A method for generating and managing, by means of electronic computation, a digital equivalent (ED) of a physical piece or artefact, in particular of a physical piece or artefact of artistic and/or historical and/or cultural value, wherein the method comprises:
dynamically generating and certifying visual contents (CV), based on digital images (DI) and/or other digital information of the physical piece or artefact acquired or received dynamically, to generate certified visual contents (CVC), accessible by means of electronic processing means, so as to allow a two-dimensional and/or three-dimensional display of the physical piece or artefact, wherein the certification step is carried out by means of a distributed electronic certification system interoperating with said electronic processing means;
dynamically recording and certifying operations (O) performed on the physical piece or artefact and/or events (E) related to the physical piece or artefact and/or documentation (D) or reporting (R) relating to the physical piece or artefact, by means of said distributed electronic certification system interoperating with said electronic processing means, to generate a set of certified dynamic digital data (DDC) representative of the history of the physical piece or artefact;
generating a digital database representing the digital equivalent (ED) of the physical piece and/or artefact, based on both said certified visual contents (CVC) and said set of certified dynamic digital data (DDC) representative of the history of the physical piece or artefact;
wherein said step of generating a digital database representing the digital equivalent (ED) of the physical piece and/or artefact comprises generating a database constantly updated with visual contents and events relating to the physical piece, creating a unique and dynamically updated link between the physical piece and the equivalent digital piece;
generating and certifying a digital contract of ownership or use (CD) of said equivalent digital piece (ED), by means of a system for generating and certifying digital contracts, interoperating with said electronic processing means.

2. A method according to claim 1, wherein said digital contract of ownership or use (CD) of the equivalent digital piece (ED) is a dynamically variable digital contract, wherein the certified data which make up the database included in the equivalent digital piece (ED) are dynamically updatable, and represent a dynamic digital equivalent of the piece of art.

3. A method according to claim 1, wherein said visual contents (CV) comprise visual contents with augmented and/or virtual reality.

4. A method according to claim 1, wherein the digital equivalent (ED) of the physical piece and/or artefact comprises both said certified visual contents (CVC) and said set of certified dynamic digital data (DDC) representative of the history of the physical piece or artefact.

5. A method according to claim 1, wherein the physical piece or artefact of artistic and/or historical and/or cultural value is a piece of art owned by a museum or by a public or private institution or organization of artistic and/or historical and/or cultural nature.

6. A method according to claim 1, wherein said visual contents (CV) are usable by means of user devices, such as a computer or a mobile device or a smartphone, adapted to communicate and interoperate digitally with said electronic processing means.

7. A method according to claim 1, wherein said electronic processing means comprise a computerized platform comprising one or more electronic processors capable of carrying out operations based on one or more software programs stored therein and executable thereby.

8. A method according to claim 1, wherein said distributed electronic certification system comprises an electronic certification system based on Blockchain technology.

9. A method according to claim 1, wherein said step of generating visual contents is carried out by means of augmented reality techniques based on tags, adapted to dynamically manage data and information relating to the physical piece or artefact.

10. A method according to claim 1, wherein said step of generating visual contents with augmented reality is carried out based on data obtained within the context of operations for digitizing artistic/cultural heritage.

11. A method according to claim 1, wherein said recording and certifying step comprises dynamically recording and certifying one or more of the following information:
documents and/or images and/or other information relating to the physical piece or artefact;
historical and/or diagnostic and/or scientific reports relating to the physical piece or artefact;
operations relating to the history of the physical piece or artefact, such as loans, logistical arrangement, cataloging, archiving.

12. A method according to claim 1, wherein the access and/or use and/or interchange of data relating to said digital equivalent of the piece (ED) occurs based on authentication procedures, based on encryption and/or cryptography techniques, wherein said authentication procedures are adapted to provide regulated access, according to a predefined hierarchy of levels, to personnel comprising the owner of the digital piece, the organization owning the physical piece, the personnel of the organization owning the physical piece, the personnel involved in the management or use of the physical piece, such as restorers or researchers.

13. A method according to claim 1, comprising the further step of allowing exchanges, loans, purchases or sales of the equivalent digital piece (ED) by means of a platform for managing the market of equivalent digital pieces, interoperating with, or included in, said electronic processing means.

14. A system for generating and managing, by means of electronic computation, a digital equivalent of a physical piece or artefact, in particular of a physical piece or artefact of artistic and/or historical and/or cultural value, wherein the system comprises electronic processing means and further comprises a distributed electronic certification system and a system for generating and certifying digital contracts, interoperating with said electronic processing means wherein said electronic processing means are configured to:
dynamically generate, based on digital images (DI) and/or other digital information of the physical piece or artefact, certified visual contents (CVC);
allow access to said certified visual contents (CVC) generated, so as to allow a two-dimensional and/or three-dimensional display of the physical piece or artefact;
generate a digital database representing the digital equivalent (ED) of the physical piece and/or artefact, based on said certified visual contents (CVC) and based on a set of certified dynamic digital data (DDC) representative of the history of the physical piece or artefact, wherein said digital database is constantly updated with visual contents and events relating to the physical piece, creating a unique and dynamically updated link between the physical piece and the equivalent digital piece;
and wherein said distributed electronic certification system is configured to:
dynamically record and certify operations (O) carried out on the physical piece or artifact and/or events (E) relating to the physical piece or artifact and/or documentation (D) or reporting (R) relating to the physical piece or artifact;
generate said set of certified dynamic digital data (DDC) representative of the history of the physical piece or artefact, based on digital data produced by said recording and certifying step;
and wherein said system for generating and certifying digital contracts is configured to:
generate and certify a digital contract (CD) of ownership or use of said digital equivalent (ED) of the piece.

15. A system according to claim 14, wherein said digital contract of ownership or use (CD) of the equivalent digital piece (ED) is a dynamically variable digital contract, wherein the certified data which make up the database included in the equivalent digital piece (ED) are dynamically updatable, and represent a dynamic digital equivalent of the piece of art.

16. (canceled)
